(19) United States
(12) Patent Application Publication
(10) Pub. No.: US 2026/0277859 A1
(43) Pub. Date: Sep. 17, 2026

(54) DATA MANAGEMENT SYSTEM, AND DATA UPDATING METHOD AND APPARATUS

(71) Applicant: CLOUD INTELLIGENCE ASSETS HOLDING (SINGAPORE) PRIVATE LIMITED, Singapore (SG)

(72) Inventor: Yubo XU, Hangzhou, Zhejiang (CN)

(73) Assignee: CLOUD INTELLIGENCE ASSETS HOLDING (SINGAPORE) PRIVATE LIMITED, Singapore (SG)

(21) Appl. No.: 19/469,359

(22) PCT Filed: Mar. 6, 2024
(86) PCT No.: PCT/CN2024/080352

§ 371 Date: Sep. 25, 2025

(30) Foreign Application Priority Data
Mar. 28, 2023 (CN) 202310321049.6

(51) Int. Cl. G06F 16/176; G06F 16/172

(52) U.S. Cl. CPC G06F 16/1767; G06F 16/172

(57) ABSTRACT

A data management system, and a data updating method are provided. The data management system includes a data storage end that maintains first original data containing original content, and a plurality of first-class access ends; the plurality of first-class access ends respectively have a shared read-only permission for the first original data; any first-class access end is used for reading loaded first original data in a read-only mode in response to an access request for the first original data, and caching first updated data generated on the basis of the read first original data; and the data storage end is used for updating the first original data according to a data updating and merging result, wherein a data source used for generating the data updating and merging result comprises the first updated data respectively cached by the plurality of first-class access ends.

### CROSS REFERENCE TO RELATED APPLICATIONS

This disclosure is a National Stage of International Stage of International Application PCT/CN2024/080352 filed on Mar. 6, 2024, which claims priority to Chinese Patent Application No. 202310321049.6, filed on Mar. 28, 2023 and entitled “DATA MANAGEMENT SYSTEM, AND DATA UPDATING METHOD AND APPARATUS”, the entire contents of the mentioned applications are incorporated herein by reference in their entireties.

### TECHNICAL FIELD

Embodiments of this specification relate to the computer field, and in particular, to a data management system, and a data updating method and apparatus.

### BACKGROUND

In some scenarios, a plurality of access ends may need to simultaneously access an original file maintained by a storage end. To meet the foregoing requirement, a storage end in a related technology typically creates a plurality of duplicates for an original file, so that the access ends can respectively load different duplicates and perform corresponding read/write operations, to implement parallel access to same original content.

However, in the related technology, because the original file and each of the duplicates of the original file may be loaded by an access end, when n access ends need to access a same original file, n−1 duplicates need to be created for the original file. It can be learned that, in this method, the original file and the duplicates of the original file, n files in total, need to be maintained, severely consuming storage resources of the storage end. In addition, the duplicates of the original files are usually created in advance. This imposes a limitation on a quantity of access ends. If the n−1 duplicates created by the storage end for the original file have been respectively loaded by n−1 access ends, for an (n+1)^{th} access end (and subsequent access ends), upon reception of a loading request sent by the (n+1)^{th} access end, the storage end needs to temporarily create a corresponding n^{th} duplicate for the (n+1)^{th} access end, and the (n+1)^{th} access end needs to wait for this duplicate to be created before starting to load and access the duplicate, affecting a loading speed and a speed of first access of the (n+1)^{th} access end. Especially when the original file contains a large amount of data, storage resource consumption and access end waiting problems become even more severe.

### SUMMARY

In view of this, one or more embodiments of this specification provide a data management system, and a data updating method and apparatus.

To achieve the foregoing objectives, one or more embodiments of this specification provide the following technical solutions.

According to a first aspect of one or more embodiments of this specification, a data management system is provided. The data management system includes a data storage end and a plurality of first-type access ends. The data storage end maintains first original data including original content. The plurality of first-type access ends each have a shared read-only permission for the first original data. Any one of the plurality of first-type access ends is configured to read loaded first original data in a read-only manner in response to an access request for the first original data, and cache first updated data generated based on the read first original data. The data storage end is configured to update the first original data based on a data updating and merging result, where a data source for generating the data updating and merging result includes the first updated data respectively cached by the plurality of first-type access ends.

According to a second aspect of one or more embodiments of this specification, a data updating method is provided and applied to any first-type access end among a plurality of first-type access ends included in a data management system. The data management system further includes a data storage end, and the data storage end maintains first original data including original content. The plurality of first-type access ends each have a shared read-only permission for the first original data. The method includes: reading loaded first original data in a read-only manner in response to an access request for the first original data; and caching first updated data generated based on the read first original data, where the first updated data respectively cached by the plurality of first-type access ends is used as a data source to generate a data updating and merging result, to enable the data storage end to update the first original data based on the data updating and merging result.

According to a third aspect of one or more embodiments of this specification, a data updating method is provided and applied to a data storage end in a data management system. The data management system further includes a plurality of first-type access ends. The data storage end maintains first original data including original content. The plurality of first-type access ends each have a shared read-only permission for the first original data. The method includes: generating a data updating and merging result by using first updated data respectively cached by the plurality of first-type access ends as a data source, where the first updated data cached by any one of the plurality of first-type access ends is generated by the first-type access end by reading loaded first original data in a read-only manner, and the first original data is loaded by the first-type access end in response to an access request for the first original data; and updating the first original data based on the data updating and merging result.

According to a fourth aspect of one or more embodiments of this specification, a data updating apparatus is provided and used in any first-type access end among a plurality of first-type access ends included in a data management system. The data management system further includes a data storage end, and the data storage end maintains first original data including original content. The plurality of first-type access ends each have a shared read-only permission for the first original data. The apparatus includes: an original data loading unit, configured to read loaded first original data in a read-only manner in response to an access request for the first original data; and an updated data cache unit, configured to cache first updated data generated based on the read first original data, where the first updated data respectively cached by the plurality of first-type access ends is used as a data source to generate a data updating and merging result, to enable the data storage end to update the first original data based on the data updating and merging result.

According to a fifth aspect of one or more embodiments of this specification, a data updating apparatus is provided and used in a data storage end in a data management system. The data management system further includes a plurality of first-type access ends. The data storage end maintains first original data including original content. The plurality of first-type access ends each have a shared read-only permission for the first original data. The apparatus includes: a merging result generation unit, configured to generate a data updating and merging result by using first updated data respectively cached by the plurality of first-type access ends as a data source, where the first updated data cached by any one of the plurality of first-type access ends is generated by the first-type access end by reading loaded first original data in a read-only manner, and the first original data is loaded by the first-type access end in response to an access request for the first original data; and an original data updating unit, configured to update the first original data based on the data updating and merging result.

According to a sixth aspect of one or more embodiments of this specification, an electronic device is provided and includes: a processor; and a storage, configured to store instructions executable by the processor. The processor runs the executable instructions to implement the method according to either the third aspect or the fourth aspect.

According to a seventh aspect of one or more embodiments of this specification, a computer-readable storage medium is provided and has computer instructions stored thereon, where the instructions, when executed by a processor, implement the steps of the method according to either the third aspect or the fourth aspect.

### BRIEF DESCRIPTION OF THE DRAWINGS

In the accompanying drawings, unless otherwise specified, same reference numerals throughout a plurality of accompanying drawings represent the same or similar parts or elements. These accompanying drawings may not be drawn to scale. It should be understood that these accompanying drawings merely describe some implementations disclosed in this disclosure, and should not be construed as limiting the scope of this disclosure.

FIG. 1 is a schematic diagram of a process of accessing data in some situations.

FIG. 2 is a schematic diagram of an architecture of a data management system according to an exemplary embodiment.

FIG. 3 is a schematic diagram of a process of accessing data according to an exemplary embodiment.

FIG. 4 is a schematic diagram of another process of accessing data according to an exemplary embodiment.

FIG. 5 is a schematic diagram of a data updating method according to an exemplary embodiment.

FIG. 6 is a schematic diagram of another data updating method according to an exemplary embodiment.

FIG. 7 is a schematic diagram of a structure of a device according to an exemplary embodiment.

FIG. 8 is a block diagram of a data updating apparatus according to an exemplary embodiment.

FIG. 9 is a block diagram of another data updating apparatus according to an exemplary embodiment.

### DETAILED DESCRIPTION

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations consistent with one or more embodiments of this specification. On the contrary, the implementations are merely examples of apparatuses and methods that are described in detail in the appended claims and that are consistent with some aspects of one or more embodiments in this specification.

It should be noted that, in another embodiment, corresponding method steps are not necessarily performed in a sequence shown and described in this specification. In some other embodiments, the methods may include more or fewer steps than those described in this specification. In addition, a single step described in this specification may be separated in a plurality of steps in another embodiment. Conversely, a plurality of steps described in this specification may be combined in a single step in another embodiment.

As described above, a storage end in a related technology typically creates a plurality of duplicates for an original file, so that the access ends respectively load different duplicates and perform corresponding read/write operations, to implement parallel access to same original content.

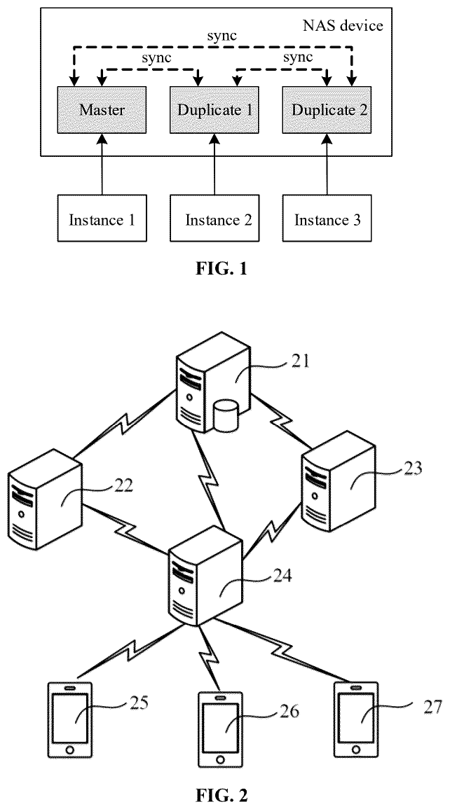

A cloud desktop service is used as an example. It is assumed that personal information (that is, original content) of a user is recorded in an original file, the file is maintained by a network attached storage (Network Attached Storage, NAS) device, and a plurality of cloud servers that the user logs into at the same time by using a user account of the user all need to access the personal information. The cloud server may be an infrastructure as a service (Infrastructure as a Service, IaaS)-level cloud computing service, and may be configured to provide elastic and scalable services for a user, to help improve utilization efficiency of cloud service resources. Refer to FIG. 1. For an original file master, the NAS device may create a plurality of duplicates, for example, duplicate1 and duplicate2, for the original file master. Based on this, a plurality of cloud server instances (Instances) (assuming that there are three instances, that is, n=3) that the user logs into may load and access different files, respectively. For example, instance1 accesses the master, and instance2 and instance3 access duplicate1 and duplicate2, respectively. In addition, “sync” among files is used to identify data synchronization to be performed among the files. For example, when instance3 logs out (that is, the user exits a login status for instance3), a change made by instance3 to duplicate2 may be updated to the master and duplicate1. Details are not described herein.

It can be learned that, in the related technology, because each of the original file and the duplicates of the original file may be loaded by one instance, when three instances need to access a same piece of personal information, at least two duplicates need to be created for the original file. It can be learned that, in this method, a total of three pieces of data (that is, the original file and two duplicates of the original file) needs to be maintained, severely consuming storage resources of the storage end. In addition, the duplicates, that is, duplicate1 and duplicate2, are usually created in advance. This imposes a limitation on a quantity of instances. If the two duplicates created by the NAS device for the master have been loaded by instance2 and instance3, respectively, when the user continues to log into a new instance4 (even instance5, instance6, and the like) later, upon reception of a data loading request sent by the new instance, the NAS needs to temporarily create a corresponding 3^{rd} duplicate (that is, duplicate3) for the new instance, and instance4 needs to wait for the duplicate to be created before starting to load and access the duplicate, affecting a startup speed of instance4 and a speed of first access to the personal information. Especially when the master contains a large amount of data, NAS storage resource consumption and instance4 waiting problems become even more severe.

For the foregoing problems existing in the related technology, this specification provides a data updating solution, in which a data storage end maintains first original data including original content, and a plurality of first-type access ends, each having a shared read-only permission for the first original data, each read loaded original data in a read-only manner and cache first updated data generated based on the original data (instead of updating the original data in real time), to reduce a quantity of pieces of data corresponding to the original content that the data storage end needs to maintain. The following describes the method in detail with reference to the accompanying drawings.

FIG. 2 is a schematic diagram of an architecture of a data management system according to an exemplary embodiment. The system may include a data storage end 21 and a plurality of servers, for example, servers 22 to 24 (that is, a server 22, a server 23, and a server 24; the same applies hereinafter).

The system may include a plurality of first-type access ends. For example, each of the servers 22 to 24 may be used as a first-type access end. The data storage end 21 may maintain first original data including original content. The plurality of first-type access ends each have a shared read-only permission for the first original data, and may read loaded first original data in a read-only manner. Any server in the data management system may be a physical server including an independent host, or may be a virtual server, a cloud server, or the like supported by a host cluster. The data storage end 21 may be in any form, for example, may be a structured or non-structured database, or may be the foregoing NAS device. This is not limited in one or more embodiments of this specification.

In an embodiment of this specification, the data storage end is configured to maintain the first original data including the original content, and the plurality of first-type access ends may separately read the first original data in a read-only manner. Read operations performed by different first-type access ends on the data may be performed in parallel. Therefore, simultaneous access to the original content by the plurality of first-type access ends may be implemented.

The system may be used in a plurality of scenarios. Correspondingly, the data storage end and the first-type access ends may be in a plurality of forms. For example, when the data storage end is a database corresponding to a server, and the first-type access ends are a plurality of clients corresponding to the server, the plurality of clients may separately and independently access public data (for example, a basic component of an application supported by the server) stored in the database.

For another example, the data management system may also be used in a cloud desktop scenario. A cloud desktop is also referred to as desktop virtualization, a cloud computer, and the like, and a computing mode of the cloud desktop may replace a conventional local computer. A user does not need to purchase a system unit of a computer, and components such as a CPU, a memory, and a hard disk drive required for running of a system unit may be implemented and provided by resources of a cloud desktop server based on a virtualization technology. The user may use any form of terminal device as a cloud desktop client, which is connected to the cloud desktop server through a network. The cloud desktop client and the cloud desktop server work together to form a complete computer in the cloud desktop scenario.

The data management system may further include a plurality of electronic devices, such as mobile phones 25 to 27. A client program may run in any mobile phone, so that the mobile phone is implemented as a cloud desktop client in a cloud desktop system. The cloud desktop client may essentially be an application, and the application may be installed on a mobile phone in advance, so that the client can be started and run on the terminal device. Certainly, when an online “client” based on, for example, a HTML5 technology is used, the client can be obtained and run without needing to install a corresponding application on the mobile phone. In addition, the mobile phones 25 to 27 are merely one type of electronic device that can be used by the user. The user may further use the following types of electronic devices: a tablet device, a notebook computer, a personal digital assistant (Personal Digital Assistant, PDA), a wearable device (for example, smart glasses and a smartwatch), a virtual reality (Virtual Reality, VR) device, an augmented reality (Augmented Reality, AR) device, and the like. The electronic device used as an application client may include hardware such as a control module, a communication module, a display, a keyboard, and a mouse, so that the user can exchange information with an application server by using the foregoing hardware. Actually, the user may alternatively use a cloud desktop dedicated device. For example, a cloud desktop client may be installed on the device in advance. The user only needs to connect the device to a corresponding input/output device, and can then access an application running on a corresponding cloud desktop server via the cloud desktop client by performing a corresponding operation, thereby utilizing a cloud desktop service provided by the device.

In addition, a cloud desktop instance may be deployed on the server 24. Based on an application (Application, APP) running on the instance or an application running on the server 22 and/or the server 23, the server 24 may be used as a cloud desktop server to provide a cloud desktop service for electronic devices such as the mobile phones 25 to 27, to allow a user to control running of the foregoing application. It can be learned that the cloud desktop instance running on the server 24 may be used as a server program, and any virtual machine may be implemented as a server in a cloud desktop system by running the program.

The cloud desktop instance running on the server 24 may integrate an application deployed in the instance, or may integrate an application deployed in other servers (for example, servers 22 and 23). After logging into the cloud desktop instance running on the server 24 by using a mobile phone, any user can control and start applications integrated in the instance, to implement login to servers where the applications are respectively located. In other words, that a user starts any application via the cloud desktop instance may be considered as that the user logs into a server to which the application belongs. Apparently, the user may log into a plurality of servers at the same time.

For any mobile phone user, the data storage end 21 may be configured to maintain original content such as account information and historical data generated during usage of the cloud desktop service by the user. For example, the data storage end 21 may maintain the first original data including the original content. The servers 22 to 24 may need to access the original content simultaneously, that is, a plurality of servers may require simultaneous access to the same original content. For example, the cloud desktop instance may be deployed on the server 24. Applications such as an APP 1 deployed locally, an APP 2 deployed on the server 22, and an APP 3 deployed on the server 23 are integrated in the instance. After logging into the cloud desktop instance by using the mobile phone, a user of the mobile phone 25 may control the APPs 1 to 3 to run. In this case, the servers 22 to 24 need to separately access the foregoing first original data stored by the data storage end 21, to obtain the original content to provide a corresponding service for the user. In this case, the servers 22 to 24 function as a plurality of first-type access ends that have a common requirement of accessing the original content.

This specification does not limit a specific function that can be implemented by any application. For example, the application may include an office application, a shopping application, a payment application, an instant messaging application, a music application, and/or the like. Details are not described herein.

This specification provides a data management system, configured to manage and update first original data including original content. As described above, the system includes a data storage end and a plurality of first-type access ends. The data storage end maintains first original data including original content. The plurality of first-type access ends each have a shared read-only permission for the first original data.

Any first-type access end is configured to read loaded first original data in a read-only manner in response to an access request for the first original data, and cache first updated data generated based on the read first original data. The data storage end is configured to update the first original data based on a data updating and merging result, and a data source for generating the data updating and merging result includes the first updated data respectively cached by the plurality of first-type access ends.

It should be noted that the original content may be information, data, an instruction, or the like in any form. This is not limited in this specification. A relevant party may perform a read operation and/or a write operation on the stored first original data. For example, a process in which the first-type access end accesses the original content includes a process of performing a read operation on the first original data (that is, reading the data). The shared read-only permission may be set by the data storage end for the first original data. For example, when an operating system of the data storage end is a Windows system, a manner of accessing to the first original data may be set to a shared manner by using a minifilter driver provided by the operating system. Certainly, an operating system of the data storage end (and any first-type access end) described in this specification may alternatively be iOS, Linux, Unix, or the like. This is not limited in this specification.

Before accessing the original content, each first-type access end needs to load the first original data. For example, any first-type access end may load the first original data in a startup process or after startup, or may load the first original data in a user login process or after login. For example, in a case of user login, when a user logs into any first-type access end, the first-type access end may determine an access address of the first original data based on identity information of the user, and load the first original data based on the access address. Alternatively, the identity information of the user may be submitted to the data storage end, and when the access address returned by the data storage end is received, the first original data is loaded based on the access address. Any first-type access end may record the access address of the first original data locally (for example, in a mapping relationship between a data identifier and an access address maintained by the first-type access end), to complete loading of the data. It may be understood that, after the first original data is loaded completely, the first-type access end may read the data based on the access address. Certainly, the first original data may alternatively be temporarily loaded in response to the access request, and the data is read after the loading is completed. Details are not described herein.

As described above, the plurality of first-type access ends in the data management system each have the shared read-only permission for the first original data. Therefore, the first-type access ends may separately read the loaded data in a read-only manner. Any one of the first-type access ends is used as an example. The access end may read the loaded first original data in a read-only manner in response to the access request for the first original data. For read operations performed on the first original data separately loaded by the first-type access ends, the plurality of first-type access ends may separately read the first original data in a read-only manner without affecting each other, to “share” the data. In an implementation, the plurality of first-type access ends may separately read (in a read-only manner) the first original data at different moments, or read (in a read-only manner) the first original data at a same moment. It can be learned that read operations of any two first-type access ends do not affect each other, and the two first-type access ends can learn the same original content through the read operations.

In an embodiment, any first-type access end may read the first original data in advance in a read-only manner, and cache the read data locally. Further, when the access request is received, the first original data cached locally may be read in response to the request. It may be understood that, for the first original data read in advance, after being read by the first-type access end, a duplicate of the data is cached locally, the duplicate is exactly the same as the first original data maintained by the data storage end, and the first original data that is read in response to the access request is the duplicate. In this method, a read-only operation for the first original data is performed in advance, and (a duplicate of) the read first original data is then cached locally, to facilitate subsequent rapid reading and timely updating of the data, increase a speed of response to the access request, and prevent the user from waiting for an excessively long time.

In addition, when the first original data includes a plurality of pieces of data, part of the first original data may alternatively be selected from the first original data and read in advance. For example, high-frequency data in the first original data may be determined based on historical reading and update records, and the high-frequency data is read in advance, while remaining low-frequency data is not read in advance. It may be understood that a probability that the first-type access end receives an access request for the high-frequency data is usually greater than a probability that the first-type access end receives an access request for the low-frequency data. In other words, an updating requirement of the first-type access end for the high-frequency data is greater than an updating requirement for the low-frequency data. Therefore, in this way, efficiency of updating the high-frequency data can be improved, and local storage space of the first-type access end can be saved as much as possible.

Alternatively, any first-type access end may temporarily read the first original data. For example, when any first-type access end loads the first original data in advance, the first-type access end may access the data storage end in response to the access request, and read the content specified in the access request from the loaded first original data in a read-only manner. The access request may include identifier information, to enable the first-type access end to determine, based on the identifier information, content that needs to be read from the loaded first original data. Certainly, the identifier information may be used to identify all or part of the first original data, to enable the first-type access end to read all or part of loaded first original data based on the identifier information. The identifier information may be, specifically, a content name, a data index, and the like, and a specific form of the identifier information is not limited in this specification. In this way, the first-type access end can accurately read the content specified by the access request from all the first original data, to facilitate subsequent data updating.

In an embodiment, an application may be deployed on the first-type access end, and the access request may be initiated by the application for the first original data. For example, in the foregoing cloud desktop scenario, if the first-type access end is a cloud server instance on which an APP i is deployed, an access request received by the instance may be initiated by the APP i. For example, a user of the APP i may perform a preset operation on the application. In this case, the APP i may determine the first original data in response to the preset operation, and initiate the access request for the data. For another example, when the first-type access end is a client device of an application (that is, a terminal device on which the client runs), if a preset operation performed by a user on the client is detected, the client may determine the corresponding first original data and initiate the access request for the first original data. The preset operation implemented by the user may be related to a function that can be implemented by the application, for example, editing a document, inputting text, forwarding a picture, recording audio, editing a video, or the like. This is not limited in this specification.

In an embodiment, the plurality of first-type access ends allows a same user to log into, that is, the user logs into the plurality of first-type access ends separately. In this case, the shared read-only permission of the plurality of first-type access ends may be granted by the user, and the first original data belongs to the user. Based on this, the first-type access end may read, in a read-only manner based on information about the user that has logged into the access end, the first original data that has been loaded and that belongs to the user. In this way, the first original data that belongs to the user logging into the plurality of first-type access ends can be accurately read by the first-type access end.

When the user logs into the first-type access end, the access end may record identity information (for example, an account ID, a password, and other basic information) of the user that has logged in. For a plurality of users involved in the data management system, the data storage end may separately maintain first original data belonging to each user, for example, maintain a mapping relationship between identity information of any user and first original data of the user (for example, when the mapping relationship is recorded in the form of a key-value pair, an account ID may be used as a key and corresponding first original data may be used as a value). Based on this, when any user logs into any first-type access end, the access end may read in a targeted manner, based on identity information of the user, first original data belonging to the user, and the data storage end may query the corresponding first original data by using the identity information as an index. For example, the first-type access end reads the first original data in a read-only manner, and may specifically send a read request for the first original data to the data storage end, and receive data returned by the data storage end in response to the request. The data may be considered as a read result of the first-type access end for the first original data, that is, the first original data read by the first-type access end. The read request may include identity information of a user logging into the first-type access end. Correspondingly, the data storage end may query the mapping relationship for corresponding first original data based on the identity information, and return a query result (that is, found first original data) to the first-type access end as a read result of the first-type access end.

When the first original data is read in a read-only manner in response to the access request, the first-type access end may generate the first updated data based on the first original data. The first updated data may be generated in a plurality of manners.

In an embodiment, the first-type access end may provide the read first original data to a user terminal, so that the user terminal can present the data to the user for viewing. During viewing the first original data, the user may need to update the first original data. In this case, the user may initiate an updating instruction for the data to the first-type access end, and the first-type access end may update the read first original data in response to the instruction, that is, generate the first updated data based on the first original data. In this scenario, the first-type access end reads the first original data in response to the access request, and further generates the first updated data in response to the updating instruction. It can be learned that in this case, reading and updating of the first original data by the first-type access end are separated, and both the access request and the updating instruction may be initiated by the user according to requirements of the user. It may be understood that, if the user does not initiate the updating instruction, the first-type access end does not update the first original data. In this case, the user only views the data.

In another embodiment, the access request may alternatively directly indicate a need to update the first original data. For example, when the first original data is read in a read-only manner, the first-type access end may determine an updating manner (for example, values before and after updating) indicated by the access request, and further update the read first original data based on the updating manner, that is, generate the first updated data based on the first original data. In this scenario, the first-type access end first reads the first original data in response to the access request, and then generates the first updated data based on the data.

A process of generating the first updated data based on the read first original data may include addition, deletion, modification, and the like. For example, the first original data is read and updated in response to the access request. The access request may include to-be-updated data. In this case, the access end may add the to-be-updated data to the read first original data to obtain the first updated data, or may modify data in the read first original data into the to-be-updated data to obtain the first updated data, or may delete the to-be-updated data from the read first original data to obtain the first updated data (formed by remaining data), and so on.

It should be noted that the foregoing addition, deletion, and modification operations are all performed on the first original data read by the access end, but are not performed on the first original data maintained by the data storage end. In other words, the first original data maintained by the data storage end has not been updated currently. As described above, the first updated data generated based on the read first original data is subsequently used to generate the data updating and merging result, to update, based on the result, the first original data maintained by the data storage end.

The access end may cache the generated first updated data. For example, the first updated data may be cached locally at the first-type access end, to improve a caching speed. Alternatively, the first updated data may be cached in the data storage end, that is, the first updated data is written in storage space that is different from storage space of the first original data in the data storage end. Apparently, caching the first updated data at the data storage end locally does not aim to use the data to directly update the first original data. At this time, the first original data has not been updated yet. When operating systems of the first-type access end and the data storage end are Windows systems, the first-type access end and the data storage end may locally mount another storage device as a virtual hard disk (Virtual Hard Disk, VHD) by using a VHD technology. In this case, the first-type access end may also cache the first updated data to the VHD mounted on the first-type access end or on the data storage end.

The first updated data respectively cached by the plurality of first-type access ends may be used as a data source to generate the data updating and merging result, so that the data storage end can update the first original data stored locally based on the result. The following describes a process of updating first original data by a data management system by using a cloud desktop scenario as an example.

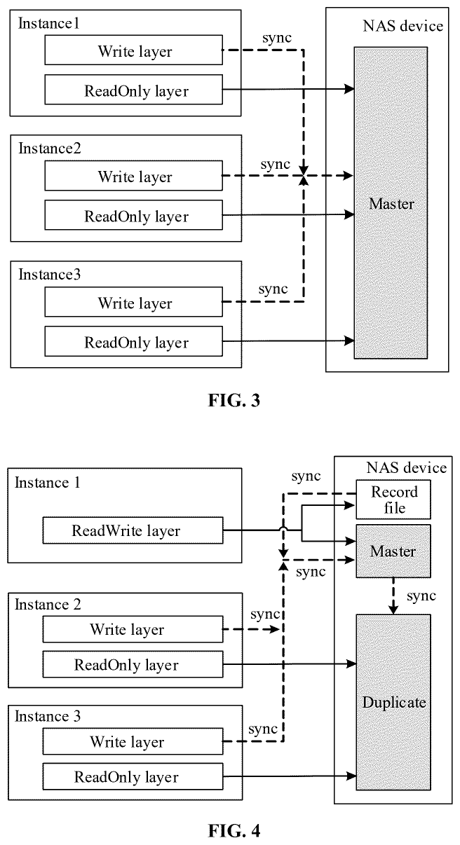

As shown in FIG. 3, the data management system includes a NAS device and three instances, that is, instance1, instance2, and instance3. The NAS device maintains first original data master including original content, and the three instances each have a shared read-only permission for the master. When a same user logs into the three instances, the master may belong to the user.

Instance1, instance2, and instance3 each are provided with a read-only component (that is, a ReadOnly layer) and a write component (that is, a write layer). Any of the instances may read the master in a read-only manner by using the ReadOnly layer of the instance. In this case, the ReadOnly layer may be considered as a data interface that is open to the instance by the NAS device and that is used to read the master. For example, any instance may temporarily read the master in a copy-on-write (that is, a copy-on-write) manner when the master needs to be updated. Alternatively, when the instance reads part or all of the master in advance, a duplicate of the data read in advance may be stored in the ReadOnly layer. In this case, the ReadOnly layer may be considered as storage space used by the instance for locally storing the data duplicate.

For any of the foregoing instances, when an access request for the master is received, the master may be loaded in response to the instruction. For example, the foregoing data duplicate read and stored in the ReadOnly layer in advance may be loaded, or part or all of content of the master indicated by the access request may be loaded by directly accessing the NAS device. After the foregoing loading is completed, the instance may generate the first updated data based on (all or part of content of) the loaded master. For example, to-be-updated data specified by a first access request (for example, included in the request) may be first determined, and then an update operation like addition, deletion, or modification may be performed on the master based on the data, to obtain the corresponding first updated data. In this case, the instance may cache the first updated data, for example, cache the data in the write layer. Then, for the first updated data that is generated based on the first updated data cached by each instance, the NAS device may update, based on the data, the master maintained by the NAS device.

In an embodiment, when the user logs out of instance3, instance3 may submit, to the NAS device, the first updated data that is cached by instance3 during current login of the user. In addition, instance3 may further notify other instances (that is, instance1 and instance2) that the user logs into to separately submit, to the NAS device, first updated data that has been cached by those instances at a current moment. Alternatively, because the instances may be independent and unaware of each other, when receiving the first updated data submitted by instance3, the NAS device may request instance1 and instance2 to provide the first updated data that has been respectively cached by instance1 and instance2 at the current moment. A specific process is shown with dashed lines labeled “sync” in FIG. 3. Certainly, when an instance of the foregoing instances does not cache the first updated data corresponding to the first original data, the instance may not submit any data.

Based on the obtained first updated data cached by at least one instance, the NAS device may merge the first updated data according to a merging strategy, and update the master maintained by the NAS device based on a corresponding merging result. The merging strategy may include a sequence of generation moments of the first updated data. For example, for any content related to updating in the first original data, the first updated data with a latest generation moment (that is, closest to a current moment) among all the first updated data is used as a merging result, so that updating of the content by different instances presents an overall updating effect in chronological order. Additionally/Alternatively, the merging strategy may include a priority order of instances, and the like. For example, when priorities of instance1, instance2, and instance3 decreases in sequence, the first updated data cached by instance1 may be directly used as the merging result for updating the first original data. Certainly, in this case, instance2 and instance3 are not required to submit the first updated data to the NAS device, but only locally store the first updated data, for instance2 and instance3 themselves to query within a runtime.

After the foregoing data updating and merging result is determined, the data storage end may update the first original data based on the data. For example, corresponding content in the master is directly replaced with the data updating and merging result, or a corresponding part in a master is directly updated based on the data updating and merging result, and finally, the first original data is updated.

It can be learned that, in this solution, each instance loads a master in a read-only manner and caches the first updated data generated based on the master by the instance, so that the NAS device updates the master based on the first updated data respectively cached by each instance, thereby orderly and reliably updating the data. It can be learned that, regardless of how many instances need to access original content simultaneously, the NAS device can meet access requirements of the instances by maintaining only one master. In this way, not only is the storage space occupied by the first original data effectively reduced, but storage resources of the NAS device are saved (in comparison with the related technology, when there are n instances, n−1 storage resources can be saved). In addition, because each instance uses a read-only manner, regardless of how many instances the master is loaded by currently, a new instance can directly load and read the master without waiting. This significantly increase a speed of loading the master by a subsequent instance and a speed of first access to original content by the subsequent instance. As shown in FIG. 3, instance4, instance5, and the like, which the user newly logs into, may directly load the master without waiting for the NAS device to temporarily create corresponding duplicates for the instances. Apparently, when the master contains a large amount of data, this solution is even more effective at resolving storage resource consumption and instance waiting problems.

Actually, a case in which a plurality of access ends simultaneously access a same piece of original content usually rarely occurs. For example, in a cloud desktop scenario, a user usually logs into only one instance at any time. Therefore, to improve content access efficiency of an access end in most cases, the foregoing solution may be further improved: A plurality of access ends that simultaneously access original data are divided into first-type access ends and a second-type access end. The second-type access end may be the 1^{st} access end (for example, the 1^{st} instance that a user logs into) that accesses the original data, and the first-type access end may be an access end (for example, another instance that the user logs into) other than the 1^{st} access end among the access ends that access the original data. The following describes the improved solution in conjunction with FIG. 4, that is, a related embodiment.

In an embodiment, in addition to maintaining the first original data, a data storage end may further maintain second original data that has the same original content as the first original data. In this case, the first original data may be a duplicate of the second original data, or the second original data may be a duplicate of the first original data. In this case, the data management system may further include a second-type access end. The access end may have an exclusive read/write permission for the second original data. Different from the shared read-only permission of each of the foregoing first-type access ends for the foregoing first original data, the exclusive read/write permission of the second-type access end for the second original data indicates that the second original data can only be read by the second-type access end (but cannot be read by any first-type access end in any manner), and the access end may perform a read/write operation on the second original data. In other words, the second-type access end not only can read the second original data (that is, perform a read operation on the data), but also can directly update the data (that is, perform a write operation on the second original data).

In this scenario, the second-type access end may trigger the data storage end to update the second original data in response to an updating request initiated for the second original data. A data source for generating the data updating and merging result may further include: an update record of the second original data by the second-type access end. For a manner of initiating an access request, content of the access request, and a specific manner for the second-type access end to receive and respond to the request, refer to the foregoing embodiments related to the access request. Details are not described herein again. In this way, the 1^{st} access end (that is, the second-type access end) that accesses the original data exclusively occupies the second original data, that is, the 1^{st} access end may directly perform a read/write operation on the data, so that not only is real-time updating of this part of data implemented, but the second-type access end does not need to store the read second original data or cache the corresponding updated data (there is no second updated data), thereby saving storage space of the access end and reducing data maintenance overhead. It may be understood that, when only one access end accesses the original data, the access end may load the second original data and directly perform a read/write operation on the second original data, to reduce as much as possible data maintenance overhead of the access end and a workload of the data storage end due to data synchronization for the maintained original data.

As shown in FIG. 4, as a data storage end in the data management system, a NAS device maintains first original data duplicate and second original data master (the duplicate may be a duplicate obtained by duplicating the master before the 1^{st} instance accesses the master). The system includes two first-type access ends (that is, instance2 and instance3) and one second-type access end (that is, instance1). For a specific process of loading duplicates by instance2 and instance3, refer to a related embodiment of loading a master by any instance shown in FIG. 3. For a process of generating and caching first updated data by instance2 and instance3, refer to a related embodiment of caching the first updated data by any instance shown in FIG. 3. Details are not described herein again.

Different from instance1 shown in FIG. 3, instance1 shown in FIG. 4 is provided with a read-write component (that is, a ReadWrite layer), and is not provided with a read-only component and a write component. Instance1 may directly read and update the master in a read/write manner by using the ReadWrite layer of instance1. In addition, for a process of updating the master, a corresponding update record (an update log or updated content) may be saved in an update record file (that is, a record file), for use in subsequent data merging. It can be learned that, in the improved solution, each first-type access end (instance2, instance3, and the like) reads the duplicate in a read-only manner, and caches updated data generated based on the duplicate in a write layer of the second-type access end, to facilitate subsequent generation of a data updating and merging result for updating the duplicate. The second-type access end (that is, instance1) exclusively occupies the master, and reads and updates the master in a read/write manner.

It can be learned that, in the foregoing improved solution, instance2, instance3, and the like each load a duplicate in a read-only manner, and respectively cache first updated data generated based on the master by instance2, instance3, and the like. In addition, the second-type access end reads the master in an exclusive manner and directly updates the master. Finally, the NAS device determines a data updating and merging result based on the first updated data respectively cached by instance2, instance3, and the like, and a pre-updating result of instance1 for the master, and updates the master and the duplicate accordingly, thereby orderly and reliably updating original data. It can be learned that, regardless of how many instances need to access original content simultaneously, the NAS device can meet access requirements of the instances by maintaining only one master and one duplicate. In this way, not only is storage space occupied by the first original data effectively reduced, but storage resources of the NAS device are saved (in comparison with the related technology, when there are n instances, n−2 storage resources can be saved). In addition, because each first-type access end uses a read-only manner, regardless of how many instances the duplicate is loaded by currently, a new instance can directly load and read the duplicate in a read-only manner without waiting. This significantly increase a speed of loading the duplicate by a subsequent instance and a speed of first access to original content by the subsequent instance. As shown in FIG. 4, instance4, instance5, and the like, which the user newly logs into, may directly load the duplicate without waiting for the NAS device to temporarily create corresponding duplicates for the instances. Apparently, when the duplicate contains a large amount of data, this solution is even more effective at resolving storage resource consumption and instance waiting problems.

In an embodiment, the data storage end may update the first original data based on the data updating and merging result in a plurality of manners. For example, the data storage end may merge, according to a first merging strategy, the first updated data respectively cached by the plurality of first-type access ends, and pre-updates the first original data based on a corresponding first data updating and merging result. Then, the data storage end merges a pre-updating result of the first original data and a pre-updating result of the second original data according to a second merging strategy, and updates the first original data and the second original data based on a corresponding second data updating and merging result. As shown in FIG. 4, the NAS device may merge first updated data respectively cached by instance2 and instance3 (the data cached by any instance may be null) according to the first merging strategy, and may pre-update the duplicate based on the corresponding first data updating and merging result. In this case, the NAS device may merge a pre-updating result of the duplicate and a pre-updating result of the master (instance1 has updated the master, and because the update may not be a final result of the master, the update is denoted as the pre-updating result of the master) according to a second merging strategy, and update the master and the duplicate based on the corresponding second data updating and merging result. The pre-updating result of the second original data may be content of the master at a current moment (after pre-updating), or may be an update record saved in the foregoing update record file. Details are not described again. The first merging strategy may include a chronological sequence of generation moments of the first updated data, or a priority sequence of the first-type access ends, or the like. The second merging strategy may include a chronological sequence of pre-updating moments of the master and generation moments of the first updated data, or a priority sequence of the access ends, or the like. Details are not described again.

For another example, the data storage end may alternatively merge, according to a third merging strategy, the pre-updating result of the second original data, and the first updated data respectively cached by the plurality of first-type access ends, and update the first original data and the second original data based on a corresponding third data updating and merging result. For example, the data storage end may merge, according to the third merging strategy, the pre-updating result of the master and the first updated data respectively cached by instance2 and instance3, and update the master and the duplicate based on the corresponding third data updating and merging result. The third merging strategy may include a chronological sequence of pre-updating moment of the master and generation moments of the first updated data, or a priority sequence of the access ends, or the like. Details are not described again. An example is shown with dashed lines labeled “sync” in FIG. 4.

In addition, during updating the master and the duplicate, the master and the duplicate may be separately updated in parallel, to improve data updating efficiency as much as possible, and reduce time consumed by a user to log out. Alternatively, the master and the duplicate may be updated in a sequence (that is, the master is updated first, and then the duplicate is updated). In this case, the updated data in the master may be directly duplicated and replaces a corresponding part in the duplicate, to reduce a workload of computation (for example, log parsing work) required to determine the updated data by the data storage end based on a data updating and merging result, thereby improving overall updating efficiency.

The foregoing embodiments describe a process of updating first original data by the first-type access end. Actually, for the first original data loaded by the first-type access end, the first-type access end may alternatively read the data in a read-only manner, without updating the data. For example, when a log-in user initiates only a viewing operation on a specific piece of data, a first-type access end may query loaded first original data for the data, and then read the data in a read-only manner and present the data to the user. In this case, between the first-type access end and a data storage end, only a read operation (in a read-only manner) on the data is involved, and a write operation on the data is not involved.

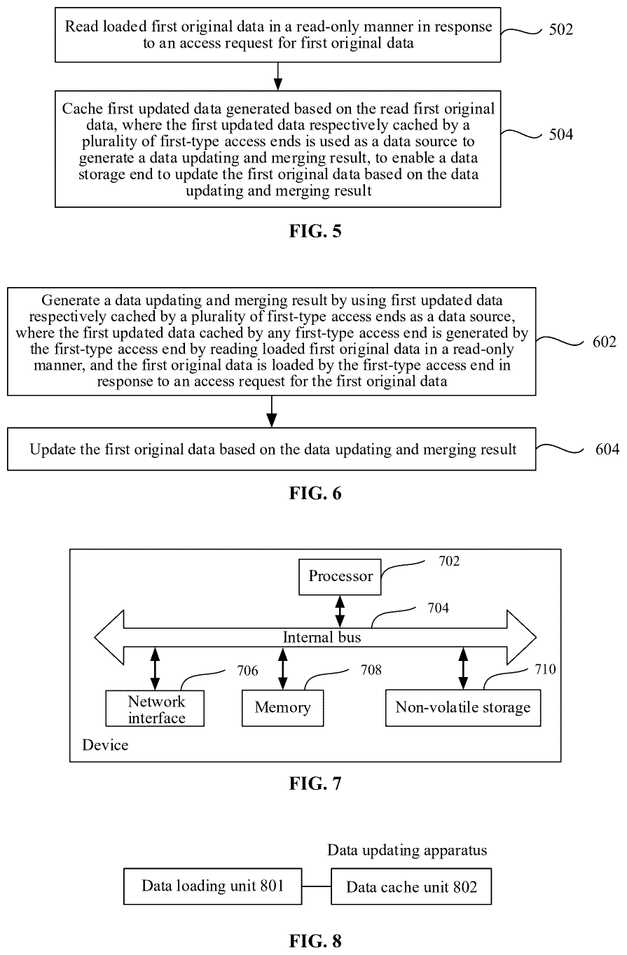

In correspondence with the foregoing related embodiments for the data management system, this specification further provides a data updating method. FIG. 5 is a flowchart of a data updating method according to an exemplary embodiment. As shown in FIG. 5, the method is applied to any first-type access end among a plurality of first-type access ends included in a data management system. The data management system further includes a data storage end. The data storage end maintains first original data including original content. The plurality of first-type access ends each have a shared read-only permission for the first original data. The method includes the following steps 502 and 504.

Step 502: Read loaded first original data in a read-only manner in response to an access request for the first original data.

Step 504: Cache first updated data generated based on the read first original data, where the first updated data respectively cached by the plurality of first-type access ends is used as a data source to generate a data updating and merging result, to enable the data storage end to update the first original data based on the data updating and merging result.

In correspondence with the foregoing related embodiments for the data management system, this specification further provides another data updating method. FIG. 6 is a flowchart of another data updating method according to an exemplary embodiment. As shown in FIG. 6, the method is applied to a data storage end in a data management system. The data management system further includes a plurality of first-type access ends. The data storage end maintains first original data including original content. The plurality of first-type access ends each have a shared read-only permission for the first original data. The method includes the following steps 602 and 604.

Step 602: Generate a data updating and merging result by using first updated data respectively cached by the plurality of first-type access ends as a data source, where the first updated data cached by any one of the plurality of first-type access ends is generated by the first-type access end by reading loaded first original data in a read-only manner, and the first original data is loaded by the first-type access end in response to an access request for the first original data.

Step 604: Update the first original data based on the data updating and merging result.

In an embodiment, the data storage end further maintains second original data that has the same original content as the first original data. The data management system further includes a second-type access end having an exclusive read/write permission for the second original data. The method further includes: updating the second original data in response to triggering by the second-type access end. The data source for generating the data updating and merging result further includes: an update record of the second original data by the second-type access end.

For specific implementation of the foregoing data updating methods, reference may be made to the descriptions in the foregoing embodiments related to the data management system, and details are not described herein again.

In this solution, a data management system includes a data storage end and a plurality of first-type access ends. The data storage end maintains first original data including original content. The plurality of first-type access ends each have a shared read-only permission for the first original data. Any first-type access end is configured to read loaded first original data in a read-only manner in response to an access request for the first original data, and cache first updated data generated based on the read first original data. The data storage end is configured to update the first original data based on a data updating and merging result, and a data source for generating the data updating and merging result includes the first updated data respectively cached by the plurality of first-type access ends.

It may be understood that, because the plurality of first-type access ends in the data management system each have the shared read-only permission for the first original data, and the first-type access ends each read the loaded first original data in a read-only manner, the first-type access ends can access same original content (that is, the original content included in the first original data). However, when each first-type access end updates first original data loaded by the first-type access end (an updating process usually involves a write operation), the first-type access end does not directly perform the write operation on the data, but generates first updated data based on read data and caches the first updated data, to avoid data chaos that may be caused by separate writing of the first-type access ends. In addition, the data storage end updates the first original data based on the data updating and merging result that is generated based on the first updated data respectively cached by the plurality of first-type access ends, so that updating results of the first-type access ends can be integrated to finally and actually update the data.

It can be learned that, in this solution, each first-type access end reads loaded first original data in a read-only manner and caches the first updated data generated by the first-type access end, so that the data storage end updates the first original data based on the first updated data cached by each first-type access end, thereby orderly and reliably updating the data. It can be learned that, regardless of how many first-type access ends need to access original content simultaneously, the data storage end only needs to maintain the first original data, to meet access requirements of the first-type access ends. In this way, not only is storage space occupied by the original data effectively reduced, but storage resources of the data storage end are saved. In addition, because each first-type access end loads and reads the first original data in a read-only manner, regardless of how many first-type access ends the first original data is loaded by currently, a new first-type access end can directly load and read the data in a read-only manner without waiting. This significantly increase a speed of loading first updated data by a subsequent first-type access end and a speed of first access to original content by the subsequent first-type access end. Apparently, when a first original file contains a large amount of data, this solution is even more effective at resolving storage resource consumption and access end waiting problems.

FIG. 7 is a schematic diagram of a structure of a device according to an exemplary embodiment. Refer to FIG. 7. On a hardware level, the device includes a processor 702, an internal bus 704, a network interface 706, a memory 708, and a non-volatile storage 710, and certainly, may further include hardware required by other functions. One or more embodiments described in this specification may be implemented based on software. For example, the processor 702 reads a corresponding computer program from the non-volatile storage 710 into the memory 708 and then runs the computer program. Certainly, in addition to a software implementation, one or more embodiments of this specification do not exclude other implementations, for example, logic devices or a combination of software and hardware. In other words, execution entities of the following processing procedures are not limited to logic units and may alternatively be hardware or logic devices.

Refer to FIG. 8. In a software implementation, a data updating apparatus is used in any first-type access end among a plurality of first-type access ends included in a data management system. The data management system further includes a data storage end. The data storage end maintains first original data including original content. The plurality of first-type access ends each have a shared read-only permission for the first original data. The apparatus includes: a data loading unit 801, configured to read loaded first original data in a read-only manner in response to an access request for the first original data; and a data cache unit 802, configured to cache first updated data generated based on the read first original data, where the first updated data respectively cached by the plurality of first-type access ends is used as a data source to generate a data updating and merging result, to enable the data storage end to update the first original data based on the data updating and merging result.

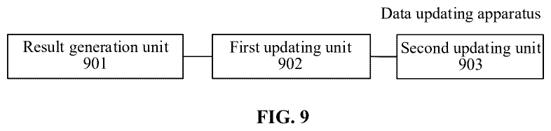

Refer to FIG. 9. In another software implementation, the data updating apparatus is used in a data storage end in a data management system. The data management system further includes a plurality of first-type access ends. The data storage end maintains first original data including original content. The plurality of first-type access ends each have a shared read-only permission for the first original data. The apparatus includes: a result generation unit 901, configured to generate a data updating and merging result by using first updated data respectively cached by the plurality of first-type access ends as a data source, where the first updated data cached by any first-type access end is generated by the first-type access end by reading loaded first original data in a read-only manner, and the first original data is loaded by the first-type access end in response to an access request for the first original data; and a first updating unit 902, configured to update the first original data based on the data updating and merging result.

In an embodiment, the data storage end further maintains second original data that has the same original content as the first original data. The data management system further includes a second-type access end having an exclusive read/write permission for the second original data. The apparatus further includes a second updating unit 903, configured to: update the second original data in response to triggering by the second-type access end. The data source for generating the data updating and merging result further includes: an update record of the second original data by the second-type access end.

The system, apparatus, module, or unit described in the foregoing embodiments may be specifically implemented by a computer chip or an entity, or implemented by a product having a certain function. A typical implementation device is a computer. A specific form of the computer may be a personal computer, a laptop computer, a cellular phone, a camera phone, a smartphone, a personal digital assistant, a media player, a navigation device, an email transceiver device, a game console, a tablet computer, a wearable device, or a combination of any two or more of these devices.

In a typical configuration, the computer includes one or more processors (for example, CPUs), an input/output interface, a network interface, and a memory.

The memory may include a form such as a volatile memory, a random-access memory (RAM), and/or a non-volatile memory in a computer-readable medium, for example, a read-only memory (ROM) or a flash RAM. The memory is an example of the computer-readable medium.

The computer-readable medium includes a non-volatile medium and a volatile medium, a removable medium and a non-removable medium, which may implement storage of information by using any method or technology. The information may be a computer-readable instruction, a data structure, a program module, or other data. An example of a storage medium in a computer includes, but is not limited to, a phase-change memory (PRAM), a static random access memory (SRAM), a dynamic random access memory (DRAM), a random access memory of another type, a read-only memory (ROM), an electrically erasable programmable read-only memory (EEPROM), a flash memory or another memory technology, a compact disc read-only memory (CD-ROM), a digital versatile disc (DVD) or another optical storage device, a cassette tape, a magnetic disk storage, a quantum memory, a graphene-based storage medium or another magnetic storage device, or any other non-transmission medium, which may be configured to store information accessible by a computing device. According to definitions in this specification, the computer-readable medium does not include transitory computer-readable media (transitory media), such as a modulated data signal and a modulated carrier.

It should be further noted that the terms “include”, “comprise” or any other variants thereof are intended to cover non-exclusive inclusion, so that processes, methods, articles, or devices including a series of elements further includes not only those elements, but also other elements that are not explicitly listed or elements inherent to the processes, the methods, the articles, or the devices. Without more limitations, an element defined by a phrase “including a/an . . . ” does not exclude other same elements existing in the processes, the methods, the articles, or the devices that include the element.

Specific embodiments of this specification are described above. Other embodiments fall within the scope of the appended claims. In some embodiments, the actions or steps recited in the claims may be performed in sequences different from those in the embodiments and an expected result may still be achieved thereby. In addition, the processes depicted in the accompanying drawings are not necessarily performed in the specific order or successively to achieve an expected result. In some implementations, multitasking and parallel processing may be feasible or beneficial.

The terms used in one or more embodiments of this specification are merely for the purpose of describing specific embodiments but are not intended to limit one or more embodiments of this specification. The terms “a/an”, “the”, and “this” in a singular form used in one or more embodiments of this specification and in the appended claims are also intended to include a plural form, unless otherwise clearly specified in the context. It should be further understood that the term “and/or” used herein indicates and includes any or all possible combinations of one or more associated listed items.

It should be understood that although the terms “first,” “second,” “third,” and the like may be used to describe various information in one or more embodiments of this specification, such information should not be limited to these terms. These terms are merely used to distinguish between information of the same type. For example, without departing from the scope of one or more embodiments of this specification, first information may also be referred to as second information. Similarly, second information may also be referred to as first information. Depending on the context, for example, the word “if” used herein may be interpreted as “while” or “when,” or “in response to determination.”

The foregoing descriptions are merely preferred embodiments of one or more embodiments of this specification, but are not intended to limit the one or more embodiments of this specification. Any modification, equivalent replacement, or improvement made within the spirit and principle of one or more embodiments of this specification shall fall within the protection scope of the one or more embodiments of this specification.

1. A data management system, comprising a data storage end and a plurality of first-type access ends, wherein the data storage end maintains first original data comprising original content, and the plurality of first-type access ends each have a shared read-only permission for the first original data, wherein
any one of the plurality of first-type access ends is configured to read loaded first original data in a read-only manner in response to an access request for the first original data, and cache first updated data generated based on the read first original data; and
the data storage end is configured to update the first original data based on a data updating and merging result, wherein a data source for generating the data updating and merging result comprises the first updated data respectively cached by the plurality of first-type access ends.

2. The system according to claim 1, wherein reading, by any one of the plurality of first-type access ends, the loaded first original data in the read-only manner comprises:
accessing the data storage end in response to the access request, and reading, in the read-only manner, content specified in the access request from the loaded first original data; or
reading the first original data cached locally, wherein the first original data is read, in the read-only manner, and cached in advance.

3. The system according to claim 1, wherein an application is deployed on any one of the plurality of first-type access ends, and the access request is initiated by the application for the first original data.

4. The system according to claim 1, wherein the shared read-only permission for the first original data is granted by a user that separately logs into the plurality of first-type access ends, and the first original data belongs to the user; and reading, by any one of the first-type access ends, the loaded first original data in the read-only manner comprises:
reading, in the read-only manner based on information about the user that has logged into the first-type access end, the loaded first original data belonging to the user.

5. The system according to claim 1, wherein the data storage end further maintains second original data that has the same original content as the first original data, and the system further comprising:
a second-type access end, having an exclusive read/write permission for the second original data, and configured to trigger the data storage end to update the second original data in response to an updating request initiated for the second original data;
wherein the data source for generating the data updating and merging result further comprises: an update record of the second original data by the second-type access end.

6. The system according to claim 5, wherein updating, by the data storage end, the first original data based on the data updating and merging result comprises:
merging, according to a first merging strategy, the first updated data respectively cached by the plurality of first-type access ends, and pre-updating the first original data based on a corresponding first data updating and merging result; and merging a pre-updating result of the first original data and a pre-updating result of the second original data according to a second merging strategy, and updating the first original data and the second original data based on a corresponding second data updating and merging result; or
merging, according to a third merging strategy, the pre-updating result of the second original data and the first updated data respectively cached by the plurality of first-type access ends, and updating the first original data and the second original data based on a corresponding third data updating and merging result, wherein
the updated first original data and the updated second original data comprise same updated content.

7. A data updating method, applied to any first-type access end among a plurality of first-type access ends comprised in a data management system, wherein the data management system further comprises a data storage end, the data storage end maintains first original data comprising original content, the plurality of first-type access ends each have shared read-only permission for the first original data, the method comprising:
reading loaded first original data in a read-only manner in response to an access request for the first original data; and
caching first updated data generated based on the read first original data, wherein the first updated data respectively cached by the plurality of first-type access ends is used as a data source to generate a data updating and merging result, to enable the data storage end to update the first original data based on the data updating and merging result.

8. A data updating method, applied to a data storage end in a data management system, wherein the data management system further comprises a plurality of first-type access ends, the data storage end maintains first original data comprising original content, the plurality of first-type access ends each have a shared read-only permission for the first original data, the method comprising:
generating a data updating and merging result by using first updated data respectively cached by the plurality of first-type access ends as a data source, wherein the first updated data cached by any one of the plurality of first-type access ends is generated by the first-type access end by reading loaded first original data in a read-only manner, and the first original data is loaded by the first-type access end in response to an access request for the first original data; and
updating the first original data based on the data updating and merging result.

9. The method according to claim 8, wherein the data storage end further maintains second original data that has the same original content as the first original data, the data management system further comprises a second-type access end having an exclusive read/write permission for the second original data, and the method further comprising:
updating the second original data in response to triggering by the second-type access end;
wherein the data source for generating the data updating and merging result further comprises: an update record of the second original data by the second-type access end.

10. (canceled)

11. (canceled)

12. An electronic device, comprising:
a processor; and
a storage, configured to store instructions executable by the processor, wherein
the processor runs the executable instructions to implement the method according to claim 7.

13. A non-transitory computer-readable storage medium, having computer instructions stored thereon, wherein the computer instructions, when executed by a processor, implement steps of the method according to claim 7.
